(19) United States
(12) Patent Application Publication
(10) Pub. No.: US 2025/0183739 A1
(43) Pub. Date: Jun. 5, 2025

(54) BRUSHLESS MOTOR

(71) Applicant: Hanon Systems, Daejeon (KR)

(72) Inventors: Ho Jun Seo, Daejeon (KR); Min Gyu Park, Daejeon (KR); Ji Min Lee, Daejeon (KR); Seong Kook Cho, Daejeon (KR)

(21) Appl. No.: 18/841,493

(22) PCT Filed: Jul. 11, 2023
(86) PCT No.: PCT/KR2023/009862

§ 371 Date: Aug. 26, 2024

(30) Foreign Application Priority Data
Aug. 5, 2022 (KR) 10-2022-0097650

(51) Int. Cl. H02K 1/276; H02K 1/16

(52) U.S. Cl. CPC H02K 1/276; H02K 1/16; H02K 2213/03

(57) ABSTRACT

The present invention relates to a motor capable of minimizing the total harmonic distortion of the no-load back electromotive force and reducing torque ripple and cogging torque. According to the present invention, it is possible to mitigate motor vibration and noise by minimizing the total harmonic distortion of the motor's no-load back electromotive force in such a way as to provide various combinations of pole and slot numbers and offering optimal parameters accordingly and by reducing torque ripple and cogging torque through optimal design of permanent magnets.

### TECHNICAL FIELD

The present invention relates to a brushless motor, and more particularly, to a motor that is capable of minimizing the total harmonic distortion of the no-load back electromotive force and reducing torque ripple and cogging torque.

### BACKGROUND ART

Driven by concerns over fossil fuel depletion and environmental pollution, policies emphasizing low emissions and fuel efficiency have spurred the development and growing popularity of hybrid vehicles utilizing both fossil fuels and electricity as power sources and electric vehicles.

Hybrid and electric vehicles obtain propulsion power through electric motors. Consequently, unlike traditional vehicle air conditioning systems that widely used mechanical compressors, there has been a recent shift towards using electric compressors.

Electric compressors are composed of an electric motor that converts electrical energy into mechanical energy and an inverter that controls the rotation of the electric motor. The electric motor of such an electric compressor typically includes a cylindrical rotor and a stator with coils wound around its outer periphery, and can be classified into distributed winding and concentrated winding types depending on the coil winding method.

In this type of electric compressor, as current flows through the coils supplied by the inverter, the rotor within the electric motor rotates, and this rotational force is transmitted to the rotating shaft. The mechanical means, which receive mechanical energy from the rotating shaft, perform a reciprocating motion to compress the refrigerant.

Electric compressors have the disadvantage of lower refrigerant compression performance compared to traditional mechanical compressors, due to the weaker driving force of the electric motor compared to the rotational power of engine-driven mechanical compressors, as well as severe vibrations and the lower control performance of inverters. Furthermore, the low efficiency of electric motors leads to wastage of electricity supplied to the vehicle.

One of the major causes of vibration and reduced precision in such electric motors is cogging torque and torque ripple generated by the interaction between permanent magnets and slots, which unavoidably exist in motors with slots.

Cogging torque is an uneven torque that occurs due to the interaction between permanent magnets and slots, causing a radial force toward the position where the magnetic energy of the motor system is minimized, i.e., toward equilibrium state, regardless of the load current, and significantly influencing motor control and precision.

To reduce cogging torque, a method has been known to structurally combine the number of magnetic poles of the permanent magnets and the number of slots appropriately. However, in the field of electric motors used for compressors in hybrid vehicles, there is still a lack of specific research results on the optimal ratio of magnetic poles to slots or on designs and structures that can reduce cogging torque and torque ripple.

FIG. 1 depicts a conventional electric compressor motor, where the conventional electric compressor motor 3 is structured with an internal rotor 4 rotating within a stator 5, configured with 6 poles and 27 slots, employing a distributed winding method with coils distributed widely over several teeth.

Due to the relatively low rotation speed (about 10,000 rpm) and high load on the motor in conventional electric compressors, there is a need to reduce the weight and size of the motor. To reduce the weight and size of the motor, a design with a higher number of poles is required. This involves increasing the number of poles and reducing the stacking of the motor, but as mentioned above, there is still a lack of specific research results in this area.

### Documents of Related Art

(Patent Document) Korean Patent Publication No. 10-2018-0113296 (published on Oct. 16, 2018)

### DISCLOSURE

### Technical Problem

The present invention has been conceived to solve the above problems and it is an object of the present invention to provide optimized pole/slot combinations and design parameters of motor components to minimize the total harmonic distortion of the motor's no-load back electromotive force and reduce torque ripple and cogging torque.

### Technical Solution

A brushless motor of the present invention may include a stator including a body hollowed out in the axial direction and a plurality of winding slots formed along the inner circumference of the body, a rotor installed axially inside the stator and including a plurality of insertion grooves formed circumferentially along the periphery thereof, and a plurality of permanent magnets inserted into the plurality of insertion grooves of the rotor, respectively, wherein the number of poles corresponding to the plurality of permanent magnets and the number of slots corresponding to the plurality of winding slots may be combined differently to reduce cogging torque and toque ripple.

According to an embodiment of the present invention, the motor may have a 10-pole 24-slot structure with the plurality of permanent magnets configured with 10 permanent magnets and the plurality of winding slots configured with 24 winding slots.

The stators and the rotors may have a ratio of a rotor radius to a stator radius, satisfying 0.594≤Rr/Rs≤0.646, where Rs denotes the status radius, Rr denotes the radius of the rotor, and Rr/Rs denotes the ratio of the rotor radius to the stator radius.

The stators may have an arc angle satisfying 28°≤α≤32°, where a denotes the arc angle formed by the center of the rotor and the ends of one of the permanent magnets.

The rotor may have a ratio of the shortest distance from the center of the rotor to one of the plurality of permanent magnets to the rotor radius Rr, satisfying 0.847≤Rm/Rr≤0.898, where Rm denotes the shortest distance to the permanent magnet.

The rotor may include a plurality of hollow holes axially penetrating the rotor, and the plurality of hollow holes may be configured with 10 holes corresponding to the plurality of permanent magnets.

The rotor may include a plurality of rivet holes formed axially penetrating the rotor, through which rivets are inserted, and the plurality of rivet holes may be configured with 10 holes formed between the adjacent hollow holes.

According to another embodiment of the present invention, the motor may have a 10-pole 12-slot structure with the plurality of permanent magnets configured with 10 permanent magnets and the plurality of winding slots configured with 12 winding slots.

The stator may include a plurality of stator teeth forming a plurality of winding slots, each tooth having a pole shoe at the end thereof, the pole shoe having the opposing surface with a predetermined curvature, facing the outer surface of the rotor, the curvature varying from the radial center of the opposing surface to the radial end.

The opposing surface of the pole shoe may have a curvature radius satisfying 30 mm≤Rs_in ≤120 mm, where Rs_in denotes the curvature radius of the opposing surface of the pole shoe.

The pole shoe may have a minimum thickness of 0.8 mm or more.

The curvature radius of the radial center of the opposing surface of the pole shoe may be 30 mm, and the curvature radius of the radial end of the opposing surface of the pole shoe may be 120 mm, the curvature radius gradually increasing from the center to the end.

The thickness of the pole shoe at the radical end of the opposing surface may be 0.8 mm.

The pole shoe may have a mirror-symmetrical shape relative to the radical center of the pole shoe.

According to still another embodiment of the present invention, the motor has a 10-pole 27-slot structure with the plurality of permanent magnets configured with 10 permanent magnets and the plurality of winding slots configured with 27 winding slots.

The stators and the rotors may have a ratio of a rotor radius to a stator radius, satisfying 0.520≤Rr/Rs≤0.646, where Rs denotes the status radius, Rr denotes the radius of the rotor, and Rr/Rs denotes the ratio of the rotor radius to the stator radius.

The stators may have an arc angle satisfying 29°≤α≤32°, where a denotes the arc angle formed by the center of the rotor and the ends of one of the permanent magnets.

The two adjacent insertion grooves, among the plurality of insertion grooves, may have a web thickness satisfying 1.6 mm≤WD≤2.2 mm, where WD denotes the web thickness corresponding to the spacing between the two adjacent insertion grooves.

### Advantageous Effects

According to the present invention, it is advantageous to mitigate motor vibration and noise by minimizing the total harmonic distortion of the motor's no-load back electromotive force in such a way as to provide various combinations of pole and slot numbers and offering optimal parameters accordingly and by reducing torque ripple and cogging torque through optimal design of permanent magnets.

### DESCRIPTION OF DRAWINGS

FIG. 1 is a diagram illustrating a conventional electric compressor motor;

FIG. 2 is a cross-sectional view of a motor according to the first embodiment of the present invention;

FIG. 3 is a cross-sectional view of a stator and rotor;

FIG. 4 is a diagram illustrating web thickness and bridge thickness;

FIG. 5 is a graph representing motor efficiency characteristics based on web thickness;

FIG. 6 is a graph representing motor efficiency characteristics based on bridge thickness;

FIG. 7 is a diagram illustrating motor design parameters;

FIG. 8 is a graph representing torque ripple characteristics based on the ratio of the rotor radius to the stator radius;

FIG. 9 is a graph representing efficiency and back electromotive force distortion characteristics of the motor based on the size of the arc angle;

FIG. 10 is a graph representing torque ripple characteristics based on the ratio of the rotor radius to the shortest distance to the permanent magnet;

FIGS. 11 and 12 are cross-sectional views of a motor according to the second embodiment of the present invention;

FIG. 13 is a diagram comparing a conventional motor and a motor of the present invention;

FIG. 14 is a diagram illustrating a pole shoe according to an embodiment of the present invention;

FIG. 15 is a graph comparing cogging torque between a conventional motor and a motor of the present invention;

FIG. 16 is a graph comparing load torque between a conventional motor and a motor of the present invention;

FIG. 17 is a cross-sectional view of a motor according to the third embodiment of the present invention;

FIG. 18 is a diagram comparing a conventional motor and a motor of the present invention;

FIG. 19 is a diagram illustrating motor design parameters;

FIG. 20 is a graph representing torque ripple characteristics based on the ratio of the rotor radius to the stator radius;

FIG. 21 is a graph representing efficiency and back electromotive force distortion characteristics of the motor based on the size of the arc angle.

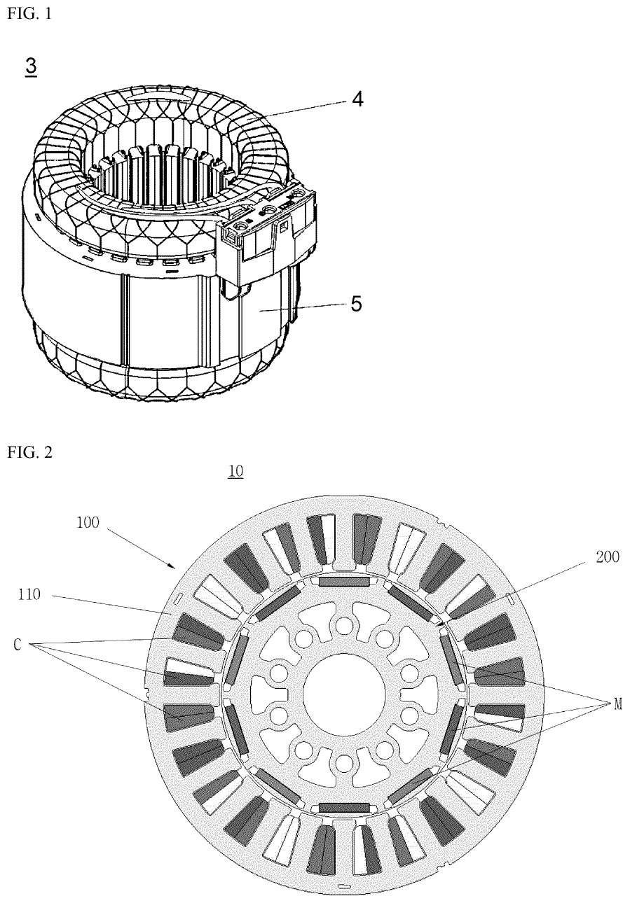

### MODE FOR INVENTION

Hereinafter, the present invention are described with reference to the accompanying drawings.

First, the motor of the present invention may be a brushless motor provided in an electric compressor for vehicles. An electric compressor for vehicles generally includes a compression unit where the refrigerant is compressed by the reciprocating motion of mechanical components, an electric motor that transmits mechanical energy to the compression unit, and an inverter that supplies electrical energy to the electric motor, and the motor of the present invention may correspond to the electric motor applicable to such a typical vehicle electric compressor. Hereinafter, the motor of the present invention will be described in detail through various embodiments.

### First Embodiment

The first embodiment of the present invention will be described. FIGS. 2 to 10 are diagrams illustrating the motor according to the first embodiment of the present invention.

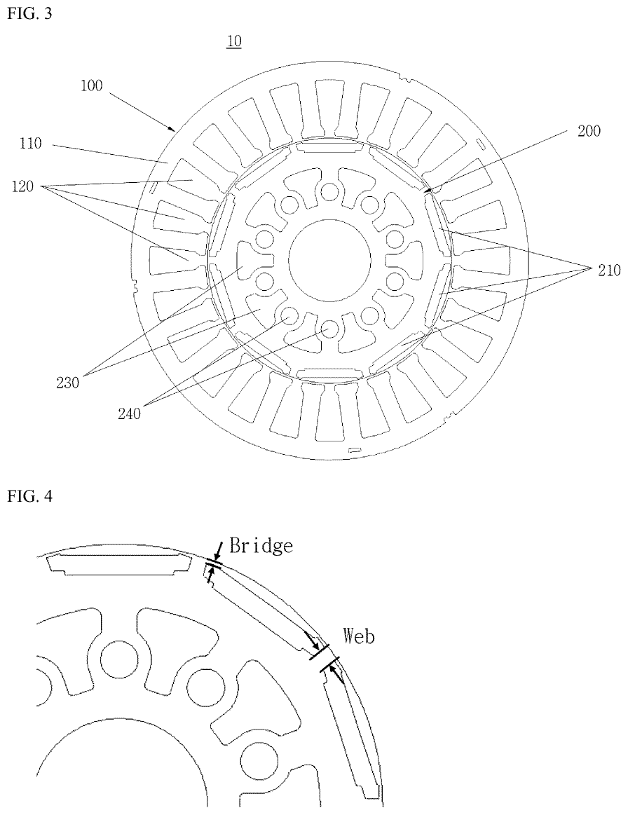

FIG. 2 is a cross-sectional view of the motor according to the first embodiment of the present invention, and FIG. 3 is a cross-sectional view of the stator and rotor; as illustrated, the motor 10 of the present invention includes a stator 100, a rotor 200, and a plurality of permanent magnets M inserted into the rotor 200.

The stator 100 includes a substantially cylindrical body 110 hollowed out in the axial direction, and a plurality of winding slots 120 are formed along the inner circumference of the hollow body 110 in the circumferential direction, and a coil C is wound in each winding slot 120. Each winding slot 120 is axially penetrating the body and spaced apart from each other, allowing the coils C to be wound in a distributed winding method spanning multiple winding slots 120.

The rotor 200 is a cylindrical member installed axially inside the stator 100, i.e., within the hollow body 110. A plurality of permanent magnets may be combined such that the rotor 200 rotates by receiving electromagnetic force generated when current flows through the coil C wound on the stator 100, and for this purpose, a plurality of insertion grooves 210 may be formed such that each of a plurality of permanent magnets is inserted on the outer circumferential side of the cylindrical member. Each insertion groove 210 is axially penetrating and spaced apart from each other in the circumferential direction.

Meanwhile, the rotor 200 may have a plurality of hollow holes 230 penetrating the rotor axially in correspondence with the permanent magnets M, and between adjacent hollow holes 230, rivet holes 240 may be respectively formed. The rivet holes 240, like the hollow holes 230, may also penetrate the interior of the rotor 200 in an axial direction, and rivets may be inserted into the rivet holes 240 to permanently join the plurality of steel plates constituting the rotor. In more detail, as described later, the hollow holes 230 may be formed with 10 corresponding in number to the permanent magnets M, and the rivet holes 240 may be formed between the hollow holes, also totaling 10. This may help improve the flux characteristics due to the permanent magnets and the manufacturability of the rotor, while reducing the weight compared to conventional electric compressor motors.

The plurality of permanent magnets M are each axially inserted into the respective insertion grooves 210, with adjacent insertion grooves 210 receiving permanent magnets M of different polarities. That is, the motor 10 of the present invention is configured with the permanent magnets M embedded inside the surface of the rotor rather than attached to the surface, allowing for the utilization of both magnetic torque (torque generated by the alignment and strength of the magnetic field) and reluctance torque (torque generated by changes in magnetic resistance), thereby achieving the same torque with less current and improving motor efficiency.

In this configuration, the motor 10 of the present invention includes 24 winding slots 120 and 10 permanent magnets M, forming a 10-pole 24-slot structure. That is, the stator 100 includes 24 winding slots 120, arranged at regular intervals, with each winding slot forming an angle of approximately 13 degrees with the adjacent winding slot 120. The rotor 200 has ten insertion grooves 210, each spaced at a uniform interval forming an angle of approximately 36 degrees with adjacent insertion grooves, and a plurality of permanent magnets M are respectively inserted into these insertion grooves 210 to correspond to the structure of the insertion grooves.

It is important to minimize the total harmonic distortion (THD) of the motor's no-load back electromotive force, as the THD closer to a sine wave reduces cogging torque and torque ripple during operation, thereby decreasing motor vibration and noise. The motor 10 of the present invention adopts a 10-pole 24-slot structure. This 10-pole 24-slot structure is an advantageous design for minimizing the total harmonic distortion of the no-load back electromotive force and significantly reducing cogging torque, which generates noise during operation.

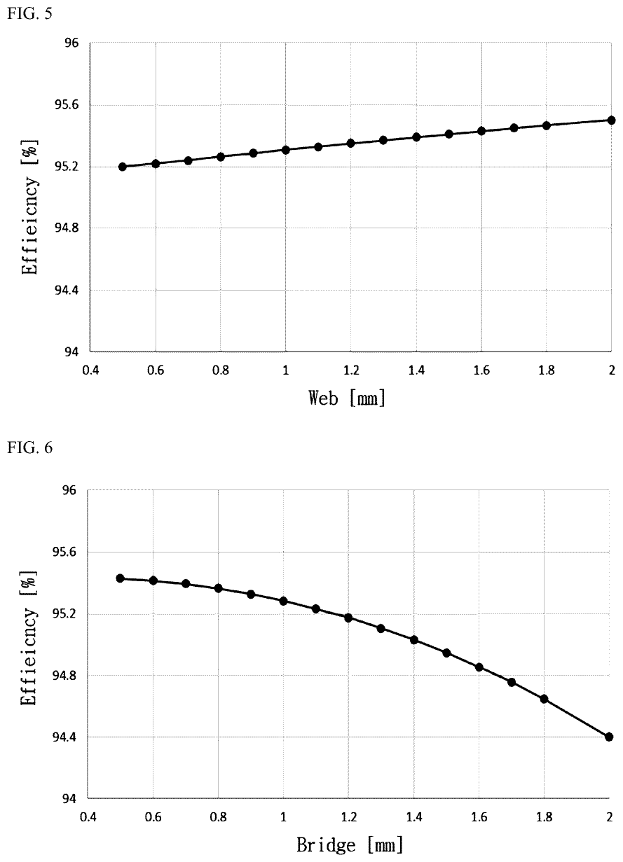

In detail, as the thickness of the web increases, the efficiency of the motor increases, while an increase in the thickness of the bridge decreases the motor's efficiency; considering these factors alongside the minimum achievable thickness for motor production, configuring the motor with 10 permanent magnets (M) can maximize both efficiency and manufacturability. FIG. 4 is a diagram illustrating web thickness and bridge thickness, FIG. 5 is a graph representing motor efficiency characteristics based on web thickness, and FIG. 6 is a graph representing motor efficiency characteristics based on bridge thickness; considering this data along with motor size and thickness, the present invention configures the motor with 10 permanent magnets M. In addition, the invention optimizes the number of poles considering the switching frequency of the inverter, configuring 24 winding slots 120 corresponding to 10 permanent magnets M, thereby minimizing the total harmonic distortion of the no-load back electromotive force.

That is, the motor of the present invention minimizes the total harmonic distortion of the no-load back electromotive force and significantly reduces cogging torque and torque ripple by adopting a 10-pole 24-slot structure, thereby reducing motor vibration and noise, while ensuring manufacturability.

To maintain high efficiency of the motor, while minimizing cogging torque and configuring the total harmonic distortion of the no-load back electromotive force as a sine wave, it is necessary to optimize the design parameters such as the magnetic angle of the permanent magnets embedded within the rotor. Hereinafter, a description is made of the optimized design of the motor that satisfy these requirements.

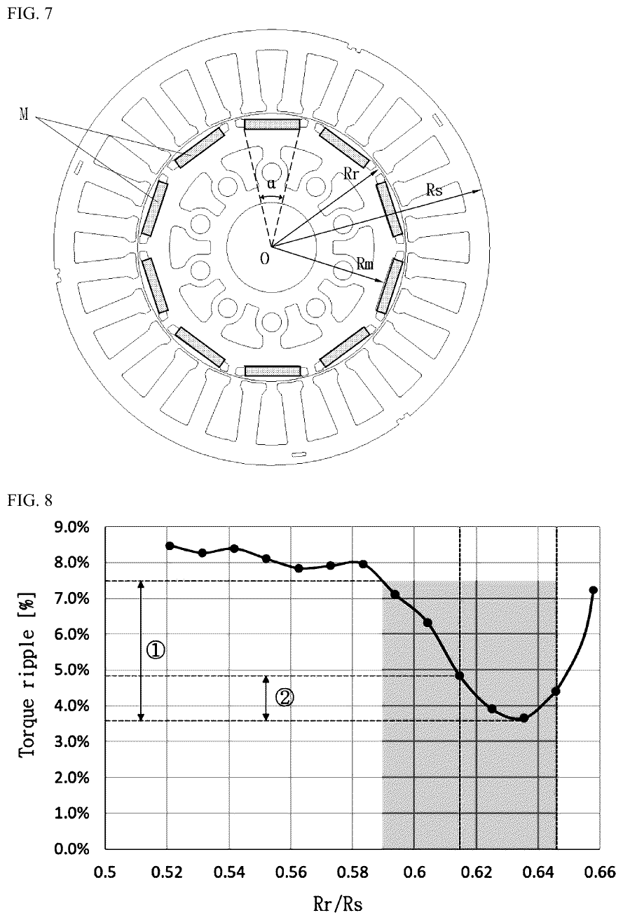

FIG. 7 is a diagram illustrating the design parameters of the motor, including the center of the rotor O, arc angle α, stator radius Rs, rotor radius Rr, and shortest distance to the permanent magnets Rm. The arc α represents the angle formed by the center of the rotor O and the both ends of one of the permanent magnets M, i.e., the angle that each permanent magnet M subtends at the center of the rotor O. The stator radius Rs represents the distance from the center of the rotor O to the outer surface of the stator 100. The rotor radius Rr represents the distance from the center of the rotor O to the outer surface of the rotor 200. The shortest distance to the permanent magnets Rm represents the shortest distance from the center of the rotor O to any of the plurality of permanent magnets M, i.e., the shortest distance between each permanent magnet M and the center of the rotor O.

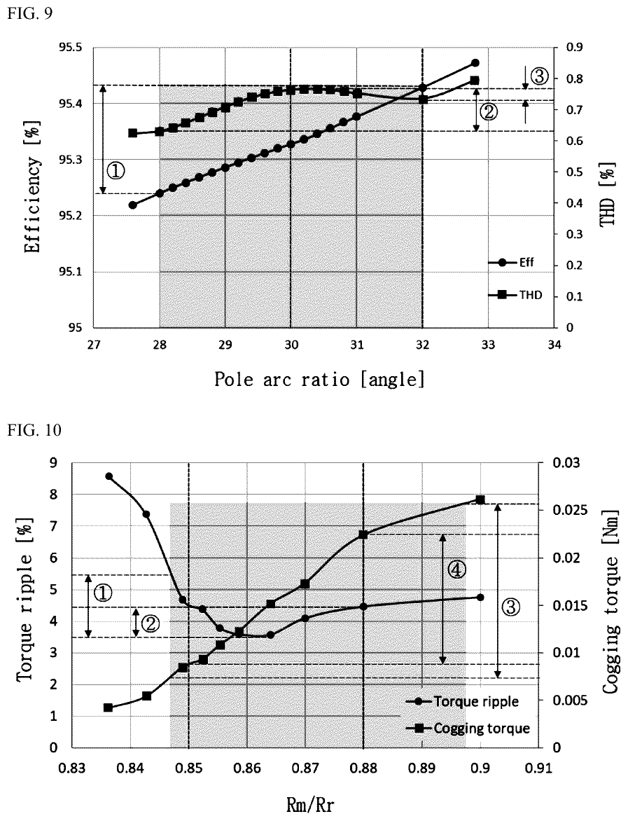

FIG. 8 is a graph representing torque ripple characteristics based on the ratio of the rotor radius to the stator radius. As demonstrated, the rotor-to-stator radius ratio (Rr/Rs) within the range of 0.594 to 0.646 during rated load results in torque ripple of approximately 7.6% or less, minimizing motor vibration and noise effectively.

TABLE 1

| [symbol] r/Rs | .56 | .58 | .60 | .62 | .64 | .66 |
|---|---|---|---|---|---|---|
| [symbol] orque | .8 | .0 | .7 | .2 | .3 | .8 |
| ripple | | | | | | |
| [%] | | | | | | |

[symbol]

indicates data missing or illegible when filed

Table 1 represents data corresponding to the graph in FIG. 8, showing that the torque ripple sharply decreases around a rotor-to-stator radius ratio (Rr/Rs) of 0.594, increases again around 0.63, and sharply increases again at 0.646. In the range of Rr/Rs from 0.594 to 0.646, the torque ripple falls within a range of approximately 7.6% to 3.6% or more as denoted by (1), and in the range of 0.618 to 0.646, the torque ripple falls within a range of approximately 4.9% to 3.6% or more as denoted by (2). That is, based on the analysis of this data, the present invention proposes a motor configured with the ratio of the rotor radius length Rr to the stator radius length Rs (Rr/Rs) to satisfy the condition 0.594≤Rr/Rs≤0.646, and preferably 0.618≤Rr/Rs≤0.646.

FIG. 9 is a graph representing efficiency and back electromotive force distortion characteristics of the motor based on the size of the arc angle. As demonstrated, maintaining an arc angle α within the range of 28° to 32° effectively reduces the total harmonic distortion (THD) of back electromotive force while maintaining efficiency above 95.23%.

TABLE 2

| α[°] | 28 | 29 | 30 | 31 | 32 | 33 |
|---|---|---|---|---|---|---|
| Eff[%] | 95.23 | 95.28 | 95.33 | 95.36 | 95.43 | 95.48 |
| THD[%] | 0.62 | 0.70 | 0.74 | 0.73 | 0.72 | 0.82 |

Table 2 presents data corresponding to the graph in FIG. 9, showing that while the motor efficiency linearly increases 95.24% to 95.43% as denoted by \textcircled{1} as the arc angle α increases, THD remains relatively low between 0.62% and 0.75% as denoted by \textcircled{2} within the arc angle α range of 28° to 32°, and even decreases from 0.75% to 0.72% as denoted by \textcircled{3} within the arc angle α range of 30° to 32°. Therefore, based on the analysis of this data, the present invention proposes a motor configured to satisfy the condition 28°≤α≤32° for the arc angle α, and preferably 30°≤α≤32°.

FIG. 10 is a graph representing torque ripple characteristics based on the ratio of the radial length of the rotor to the shortest distance to the permanent magnet. As demonstrated, within the range of radius ratio (Rm/Rr) from 0.847 to 0.898, there exists cogging torque of approximately 7% or less and torque ripple of approximately 6% or less, effectively minimizing torque ripple to reduce motor vibration and noise.

TABLE 3

| [symbol] m/Rr | .84 | .85 | .86 | .87 | .88 | .89 | .90 |
|---|---|---|---|---|---|---|---|
| [symbol] orque | .0 | .7 | .6 | .5 | .1 | .4 | .8 |
| ripple | | | | | | | |
| [%] | | | | | | | |
| [symbol] ogging | .3 | .8 | .0 | .1 | .8 | .3 | .9 |
| torque | | | | | | | |

[symbol]

indicates data missing or illegible when filed

Table 3 represents data corresponding to the graph in FIG. 10, showing that torque ripple decreases sharply as the radius ratio (Rm/Rs) increases from 0.847, increases again around 0.865, and then gradually increase up to 0.898. In the range of radius ratio (Rm/Rs) from 0.847 to 0.898, torque ripple falls within a range of approximately 5.5% to 3.6% or more as denoted by \textcircled{1}, indicating low torque ripple characteristics. In the range of radius ratio (Rm/Rs) from 0.85 to 0.88, torque ripple falls within a range of approximately 0.44% to 3.6% as denoted by \textcircled{2}, offering improved torque ripple characteristics.

Additionally, as the radius ratio (Rm/Rs) increases, cogging torque increases linearly, specifically in the range of radius ratio (Rm/Rs) from 0.847 to 0.898, exhibiting cogging torque in the range of approximately 0.007 Nm to 0.026 Nm as denoted by \textcircled{3}, indicating low cogging torque characteristics. When the radius ratio (Rm/Rs) falls within the range of 0.85 to 0.88, the cogging torque ranges from approximately 0.008 Nm to 0.022 Nm as denoted by \textcircled{4}, indicating improved cogging torque characteristics.

That is, based on the analysis of this data, the present invention proposes a motor configured with the ratio of the rotor radius length Rr to the shortest distance to the permanent magnets Rm (Rm/Rr) satisfying the condition 0.847≤Rm/Rr≤0.898, and preferably 0.85≤Rm/Rr≤0.88 for optimal performance.

The various design parameters described above are interrelated by the sizes, shapes, and arrangements of the components constituting the motor, and by considering the interrelationships among these design parameters, they can be implemented within a single motor by overlapping each parameter's range to satisfy their respective conditions, thereby maximizing the motor's efficiency, torque ripple, and cogging torque characteristics.

### Second Embodiment

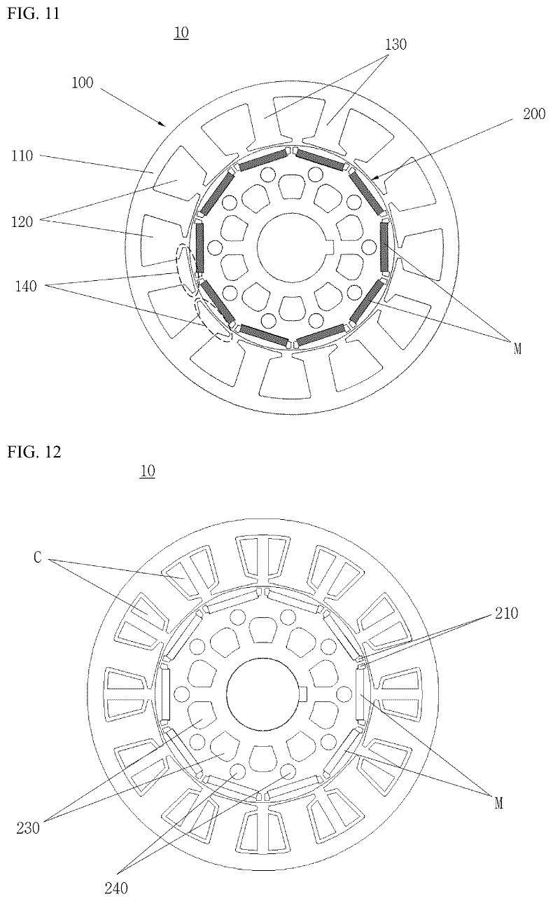

Next, the second embodiment of the present invention will be described. FIGS. 11 to 16 are diagrams illustrating the motor according to the second embodiment of the present invention. Any repetitions from the above description will be omitted to avoid redundancy.

FIGS. 11 and 12 are cross-sectional views of the motor 10 according to this embodiment, which includes 10 permanent magnets and 12 winding slots, resulting in a 10-pole, 12-slot structure. As the motor adopts a 10-pole, 12-slot structure, the cogging torque frequency is composed of 60 harmonics, providing advantages in terms of reducing vibration and noise compared to conventional motors.

In this embodiment, the pole shoe is configured to be different in shape from conventional motors. The stator is provided with a plurality of stator teeth 130 forming a plurality of winding slots, and at the end of each stator tooth 130, a pole shoe 140 extends radially outward.

Here, the opposing surface of the pole shoe 140 facing the outer circumference of the rotor 200 is called the opposing surface 140A of the pole shoe, and unlike conventional motors where the opposing surface 140A typically has the same curvature as the outer circumference of the rotor 200, the present invention features a pole shoe opposing surface 140A with a predetermined curvature, where the curvature at the radial center c of the pole shoe opposing surface 140A differs from rather than identical with the curvature at the radial end e.

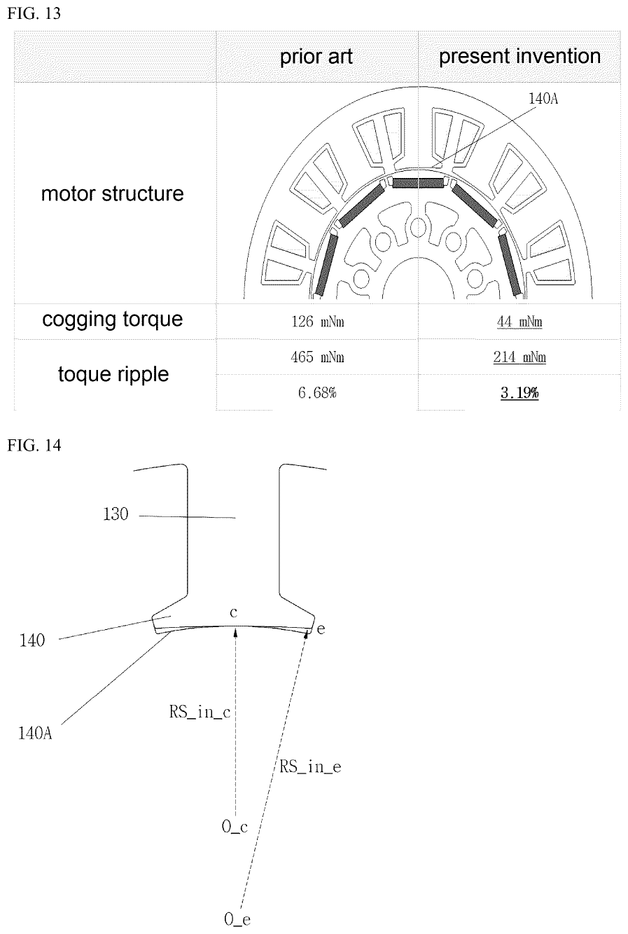

FIG. 13 is a diagram comparing a conventional motor with the motor of the present invention, showing that in the conventional motor, the opposing surface of the pole shoe has a constant curvature, resulting in a cogging torque of 126 mNm and a torque ripple of 465 mNm with a deviation 6.68%. In contrast, the present invention features a pole shoe opposing surface 140A with different curvatures at the center and the end, resulting in a cogging torque of 44 mNm and a torque ripple of 214 mNm with a deviation of 3.19%, significantly reducing cogging torque and torque ripple compared to the conventional motor.

In detail, when the radius of curvature at one point on the pole shoe opposing surface 140A is Rs_in, the present invention configures the radius of curvature Rs_in of the pole shoe opposing surface to satisfy 30 mm≤Rs_in ≤120 mm, thereby increasing the efficiency of the motor. Additionally, it is desirable for the pole shoe to have a minimum thickness, and the present invention configures the pole shoe 140 to have a minimum thickness of at least 0.8 mm.

More specific examples satisfying these conditions are as follows. FIG. 14 is a diagram illustrating a pole shoe according to an embodiment of the present invention, where the curvature radius of the radial center c of the opposing surface 140A of the pole shoe is 30 mm, and the curvature radius of the radial end e of the opposing surface 140A of the pole shoe is 120 mm, with the curvature radius gradually increasing from the center c to the end e in a uniform manner.

Additionally, as the curvature of the opposing surface 140A of the pole shoe decreases, the curvature radius Rs_in increases, and to satisfy the minimum thickness of the pole shoe 140 as described above, the thickness at the radial end e of the opposing surface 140A with the maximum curvature radius Rs_in may be configured to be 0.8 mm. Furthermore, as shown in the drawing, the pole shoe 140 of the present invention may have a mirror-symmetrical shape relative to the radial center c of the pole shoe.

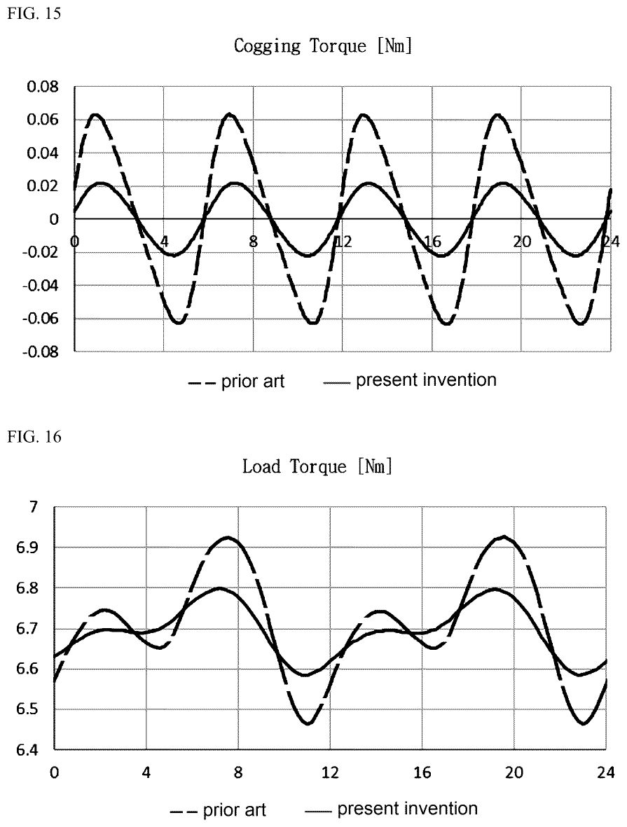

FIG. 15 is a graph comparing cogging torque between a conventional motor and a motor of the present invention, showing that the conventional motor exhibits significant cogging torque within the range of −0.06 to 0.06, while the present invention demonstrates reduced cogging torque within the range of −0.02 to 0.02.

FIG. 16 is a graph comparing load torque between a conventional motor and a motor of the present invention, showing that the conventional motor exhibits significant load torque within the range of 6.45 to 6.92, while the present invention demonstrates reduced load torque within the range of 6.58 to 6.8.

As observed above, according to this embodiment, the motor is configured in a 10-pole 12-slot structure, with the curvature radius of the pole shoe opposing surface formed within 30 to 120 mm, gradually increasing towards the end from the axial center, thereby minimizing torque ripple during operation for improved vibration and noise reduction, while also reducing the overall weight compared to conventional motors.

### Third Embodiment

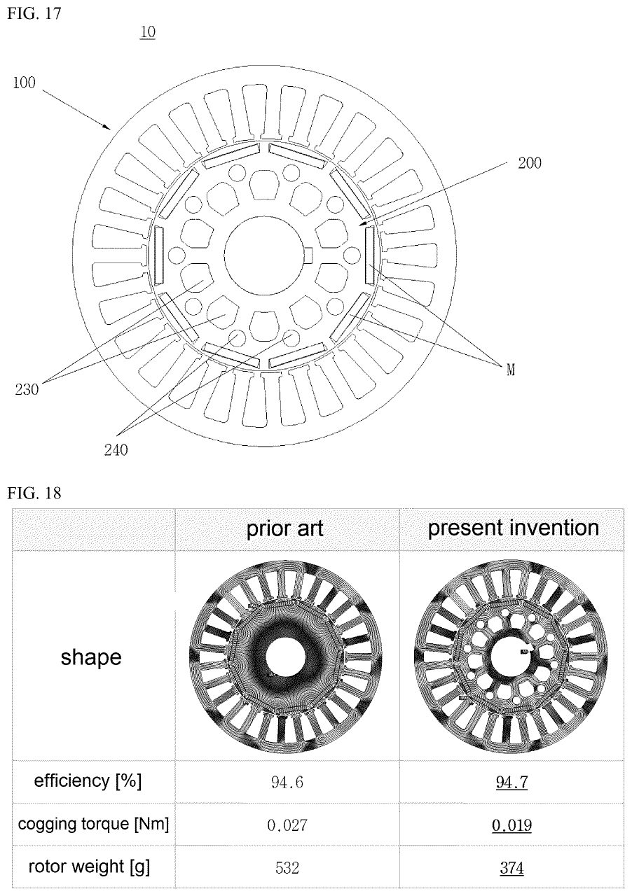

Next, the third embodiment of the present invention will be described. FIGS. 17 to 21 are diagrams illustrating the motor according to the third embodiment of the present invention. Any repetitions from the above description will be omitted to avoid redundancy.

FIG. 17 is a cross-sectional view of a motor according to the third embodiment of the present invention, where the motor 10 includes 10 permanent magnets M and 27 winding slots 120, resulting a 10-pole 27-slot structure. The impact of area changes on weight, based on the motor cross-section, is relatively larger for electrical steel sheets compared to permanent magnets, necessitating optimization of the shape to minimize the area of electrical steel sheets for reducing cogging torque, improving performance, and reducing weight in the motor. To achieve this, the present invention adopts a 10-pole 27-slot structure.

Additionally, to maintain high efficiency and achieve weight reduction within the motor, it is necessary to optimize the design of the length of permanent magnets embedded within the rotor and the design of the rotor back core. For this purpose, the motor may be configured with 10 hollow holes and rivet holes in the rotor, each corresponding to the permanent magnets.

FIG. 18 is a diagram comparing a conventional motor and a motor of the present invention, showing the conventional motor with the efficiency of 94.6%, cogging torque of 0.027 Nm, and rotor mass of 532 g, and the motor of the present invention with the efficiency of 94.7%, cogging torque of 0.019 Nm, and rotor mass of 374 g, confirming an increase in motor efficiency and a significant reduction in both cogging torque and rotor mass compared to the conventional motor.

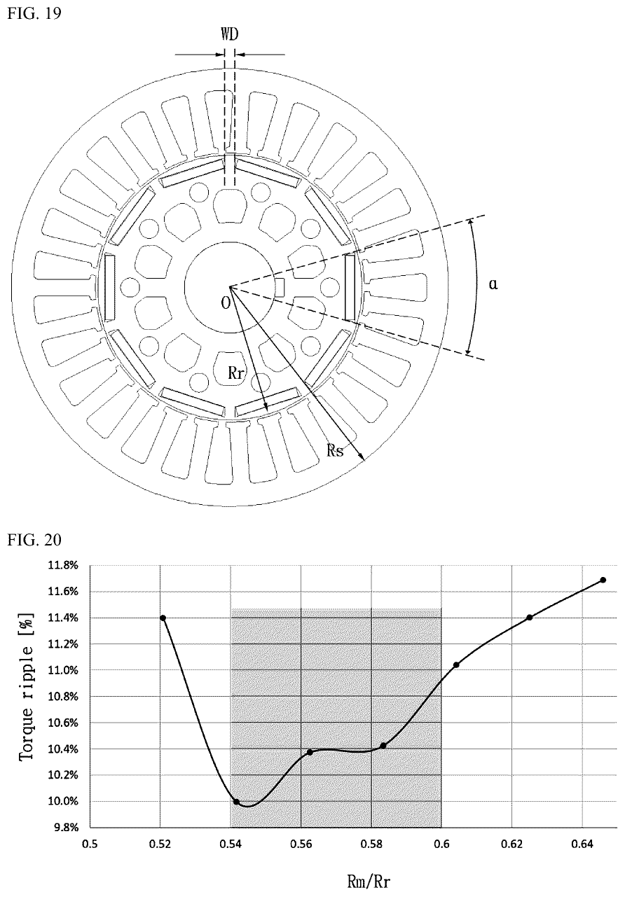

The specific figures of design parameters for this embodiment are as follows. FIG. 19 is a diagram illustrating motor design parameters, where the motor of this embodiment satisfies the conditions 0.520≤Rr/Rs≤0.646 for the ratio of rotor radius Rr to stator radius Rs, 29°≤α≤32° for the arc angle α, and 1.6 mm≤WD≤2.2 mm for the web thickness WD. The thickness WD of the web may correspond to the spacing between two adjacent insertion grooves 210. Configuring each parameters in the motor of this embodiment to satisfy these conditions can improve the efficiency of the motor and reducing the cogging torque and rotor weight.

FIG. 20 is a graph representing torque ripple characteristics based on the ratio of the rotor radius to the stator radius, showing that for this motor, the ratio of rotor radius Rr to stator radius Rs (Rr/Rs) ranges from 0.520 to 0.646, preferably from 0.54 to 0.6, within which the torque ripple is confirmed to be as small as about 10.8%.

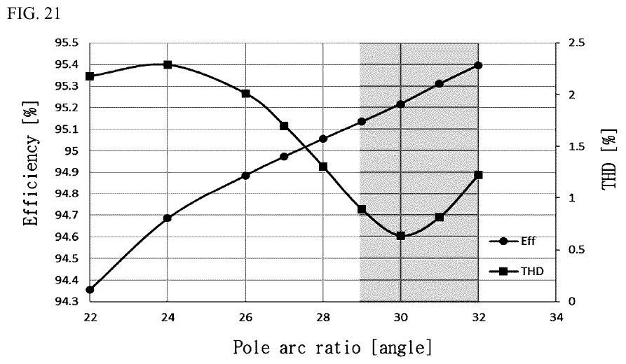

FIG. 21 is a graph representing efficiency and back electromotive force distortion characteristics of the motor based on the size of the arc angle, showing that for this motor, the arc angle α ranges from 29° to 32°, within which the motor efficiency is confirmed to be significantly high at about 95.1% or more, while the total harmonic distortion (THD) of the no-load back electromotive force is as low as about 1.2%.

As described above, according to this embodiment, the motor is constructed with a 10-pole 27-slot structure, and by using the ratio of the rotor radius to the stator radius, the arc angle, and the web thickness as design parameters and limiting each parameter to an appropriate range, vibration and noise can be minimized by reducing torque ripple, while providing high motor efficiency and effectively reducing the THD of the back electromotive force.

Although the present invention has been described with reference to the accompanying drawings and preferred embodiments, it should be understood by those skilled in the art that various modifications and changes can be made without departing from the spirit and scope of the present invention. Therefore, it should be understood that the above-described embodiments are illustrative and not limiting in all respects.

### DESCRIPTION OF REFERENCE NUMERALS

10: motor
100: stator
110: body
120: winding slot
130: stator teeth
140: pole shoe
200: rotor
210: insertion groove
230: hollow hole
240: rivet hole
C: coil
M: permanent magnet

1. A brushless motor comprising:
a stator comprising a body hollowed out in the axial direction and a plurality of winding slots formed along the inner circumference of the body;
a rotor installed axially inside the stator and comprising a plurality of insertion grooves formed circumferentially along the periphery thereof; and
a plurality of permanent magnets inserted into the plurality of insertion grooves of the rotor, respectively,
wherein the number of poles corresponding to the plurality of permanent magnets and the number of slots corresponding to the plurality of winding slots are combined differently to reduce cogging torque and toque ripple.

2. The brushless motor of claim 1, wherein the plurality of permanent magnets are configured with 10 permanent magnets, and the plurality of winding slots are configured with 24 winding slots, resulting in a 10-pole 24-slot structure.

3. The brushless motor of claim 2, wherein the stators and the rotors have a ratio of a rotor radius to a stator radius, satisfying 0.594≤Rr/Rs≤0.646, where Rs denotes the status radius, Rr denotes the radius of the rotor, and Rr/Rs denotes the ratio of the rotor radius to the stator radius.

4. The brushless motor of claim 3, wherein the stators have an arc angle satisfying 28°≤α≤32°, where a denotes the arc angle formed by the center of the rotor and the ends of one of the permanent magnets.

5. The brushless motor of claim 4, wherein the rotor has a ratio of the shortest distance from the center of the rotor to one of the plurality of permanent magnets to the rotor radius Rr, satisfying 0.847≤Rm/Rr≤0.898, where Rm denotes the shortest distance to the permanent magnet.

6. The brushless motor of claim 5, wherein the rotor comprises a plurality of hollow holes axially penetrating the rotor, and the plurality of hollow holes are configured with 10 holes corresponding to the plurality of permanent magnets.

7. The brushless motor of claim 6, wherein the rotor comprises a plurality of rivet holes formed axially penetrating the rotor, through which rivets are inserted, and the plurality of rivet holes are configured with 10 holes formed between the adjacent hollow holes.

8. The brushless motor of claim 1, wherein the plurality of permanent magnets are configured with 10 permanent magnets, and the plurality of winding slots are configured with 12 winding slots, resulting in a 10-pole 12-slot structure.

9. The brushless motor of claim 8, wherein the stator comprises a plurality of stator teeth forming a plurality of winding slots, each tooth having a pole shoe at the end thereof, the pole shoe having the opposing surface with a predetermined curvature, facing the outer surface of the rotor, the curvature of the pole shoe varying from the radial center of the opposing surface to the radial end.

10. The brushless motor of claim 9, wherein the opposing surface of the pole shoe has a curvature radius satisfying 30 mm≤Rs_in ≤120 mm, where Rs_in denotes the curvature radius of the opposing surface of the pole shoe.

11. The brushless motor of claim 10, wherein the pole shoe has a minimum thickness of 0.8 mm or more.

12. The brushless motor of claim 11, wherein the curvature radius of the radial center of the opposing surface of the pole shoe is 30 mm, and the curvature radius of the radial end of the opposing surface of the pole shoe is 120 mm, the curvature radius gradually increasing from the center to the end.

13. The brushless motor of claim 12, wherein the thickness of the pole shoe at the radical end of the opposing surface is 0.8 mm.

14. The brushless motor of claim 13, wherein the pole shoe has a mirror-symmetrical shape relative to the radical center of the pole shoe.

15. The brushless motor of claim 1, wherein the plurality of permanent magnets are configured with 10 permanent magnets, and the plurality of winding slots are configured with 27 winding slots, resulting in a 10-pole 27-slot structure.

16. The brushless motor of claim 15, wherein the stators and the rotors have a ratio of a rotor radius to a stator radius, satisfying 0.520≤Rr/Rs≤0.646, where Rs denotes the status radius, Rr denotes the radius of the rotor, and Rr/Rs denotes the ratio of the rotor radius to the stator radius.

17. The brushless motor of claim 16, wherein the stators have an arc angle satisfying 29°≤α≤32°, where a denotes the arc angle formed by the center of the rotor and the ends of one of the permanent magnets.

18. The brushless motor of claim 17, wherein the two adjacent insertion grooves, among the plurality of insertion grooves, have a web thickness satisfying 1.6 mm≤WD≤2.2 mm, where WD denotes the web thickness corresponding to the spacing between the two adjacent insertion grooves.
